(19) United States
(12) Patent Application Publication
(10) Pub. No.: US 2014/0120335 A1
(43) Pub. Date: May 1, 2014

(54) FLOAT GLASS FOR CHEMICAL STRENGTHENING

(71) Applicant: ASAHI GLASS COMPANY, LIMITED, Chiyoda-ku (JP)

(72) Inventors: Kazuhiko YAMANAKA, Tokyo (JP); Hitoshi ONODA, Tokyo (JP); Aya YAMAMOTO, Tokyo (JP); Yusuke FUJIWARA, Tokyo (JP); Tetsushi TAKIGUCHI, Tokyo (JP)

(73) Assignee: ASAHI GLASS COMPANY, LIMITED, Chiyoda-ku (JP)

(21) Appl. No.: 14/146,167

(22) Filed: Jan. 2, 2014

Related U.S. Application Data
(63) Continuation of application No. PCT/JP2012/066275, filed on Jun. 26, 2012.

(30) Foreign Application Priority Data
Jul. 1, 2011 (JP) 2011-147493

(51) Int. Cl. C03C 3/087; C03C 3/085; C03C 21/00

(52) U.S. Cl. CPC C03C 3/087; C03C 21/002; C03C 3/085
USPC 428/220; 501/69; 501/70

(57) ABSTRACT

A float glass, which is produced by a float process, has a bottom surface to contact a molten metal during forming and a top surface facing the bottom surface, and is capable of having, after chemical strengthening, a surface compressive stress of 600 MPa or more and a depth of a compressive stress layer of 15 μm or more from a surface thereof. Before chemical strengthening, a difference obtained by subtracting a surface compressive stress value σ_{CB} in the bottom surface from a surface compressive stress value σ_{CT} in the top surface is −0.6 MPa or more and 0.25 MPa or less.

### TECHNICAL FIELD

The present invention relates to a float glass for chemical strengthening, which is capable of having, after chemical strengthening, a surface compressive stress of 600 MPa or more and a depth of a compressive stress layer of 15 μm or more from a surface thereof.

### BACKGROUND ART

In recent years, in a flat panel display device such as a mobile phone or a personal digital assistant (PDA), in order to enhance protection and beauty of a display, a thin sheet-shaped cover glass is arranged on a front surface of the display so as to cover a region wider than an image display area. Weight reduction and thickness reduction are required for such a flat panel display device, and therefore, a cover glass used for protecting the display is also required to reduce its thickness. However, when the thickness of the cover glass is reduced, the strength thereof is decreased, and the cover glass itself may break during use or by drop during carrying. There is therefore a problem that the primary role of protecting the display device cannot be performed.

For this reason, in a conventional cover glass, in order to improve scratch resistance, a soda-lime glass produced by a float process is chemically strengthened to form a compressive stress layer on a surface thereof, thereby enhancing scratch resistance of the cover glass. The surface compressive stress of a chemically strengthened float glass obtained by chemically strengthening the conventional soda-lime glass was about 500 MPa, and the depth of the compressive stress layer was approximately 10 μm.

On the other hand, it is reported that warpage occurs in the chemically strengthened float glass obtained by chemically strengthening the soda-lime glass formed by the float process (for example, see Patent Document 1). According to this Patent Document 1, it is described that the warpage is caused by invasion of a molten metal in a bottom surface to contact the molten metal during float forming.

In recent years, the higher scratch resistance is required for a cover glass and the like, and a chemically strengthened float glass having a surface compressive stress of 600 MPa or more and a depth of a compressive stress layer of 15 μm or more has been developed.

### PRIOR ART DOCUMENTS

### Patent Documents

Patent Document 1: JP-A-62-191449

### SUMMARY OF THE INVENTION

### Problems that the Invention is to Solve

However, there has been a problem that the warpage due to chemical strengthening becomes apparent in the chemically strengthened float glass having a surface compressive stress of 600 MPa or more and a depth of a compressive stress layer of 15 μm or more, compared to the conventional chemically strengthened float glass having a surface compressive stress of about 500 MPa and a depth of a compressive stress layer of about 10 μm.

An object of the invention is therefore to provide a float glass for chemical strengthening, which can suppress the warpage due to chemical strengthening and is capable of having, after chemical strengthening, a surface compressive stress of 600 MPa or more and a depth of a compressive stress layer of 15 μm or more from a surface thereof.

### Means for Solving the Problems

The present inventors have made various measurements and investigations. As a result, in a float glass for chemical strengthening, it has been found that the difference occurs in remaining surface compressive stress between a bottom surface to contact a molten metal and a top surface, and the surface compressive stress in the top surface is higher than that in the bottom surface. Then, the present inventors have found that the occurrence of warpage due to chemical strengthening is caused by the difference in remaining surface compressive stress between the top surface and the bottom surface, in addition to invasion of the molten metal in the bottom surface to contact the molten metal during float forming, which has previously been believed. Then, the present invention has been achieved.

In order to reduce the warpage of the float glass due to chemical strengthening, the invention provides the following aspects. In the present invention, a float glass before chemical strengthening, which is formed by a float process, is called a float glass for chemical strengthening, and one obtained by chemically strengthening this float glass for chemical strengthening is called a chemically strengthened float glass.

(1) A float glass for chemical strengthening, which is produced by a float process, has a bottom surface to contact a molten metal during forming and a top surface facing the bottom surface, and is capable of having, after chemical strengthening, a surface compressive stress of 600 MPa or more and a depth of a compressive stress layer of 15 μm or more from a surface thereof,

wherein, before chemical strengthening, a difference obtained by subtracting a surface compressive stress value σ_{CB} in the bottom surface from a surface compressive stress value σ_{CT} in the top surface is −0.6 MPa or more and 0.25 MPa or less.

(2) The float glass for chemical strengthening according to (1), wherein, before chemical strengthening, the difference obtained by subtracting the surface compressive stress value σ_{CB} in the bottom surface from the surface compressive stress value σ_{CT} in the top surface is less than 0 MPa.

(3) The float glass for chemical strengthening according to (1) or (2), which has a sheet thickness of 1.5 mm or less.

(4) The float glass for chemical strengthening according to any one of (1) to (3), which is an alkali aluminosilicate glass.

### Advantages of the Invention

According to the float glass for chemical strengthening of the invention, warpage of the float glass due to chemical strengthening can be suppressed.

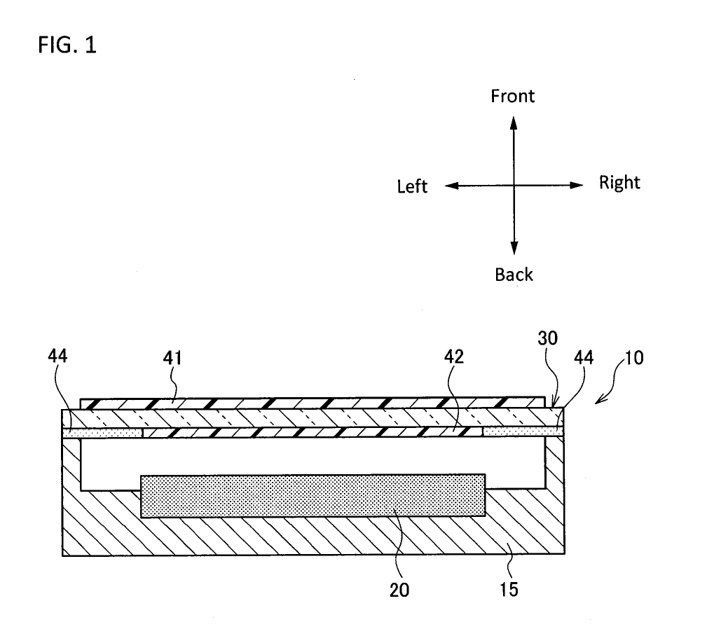

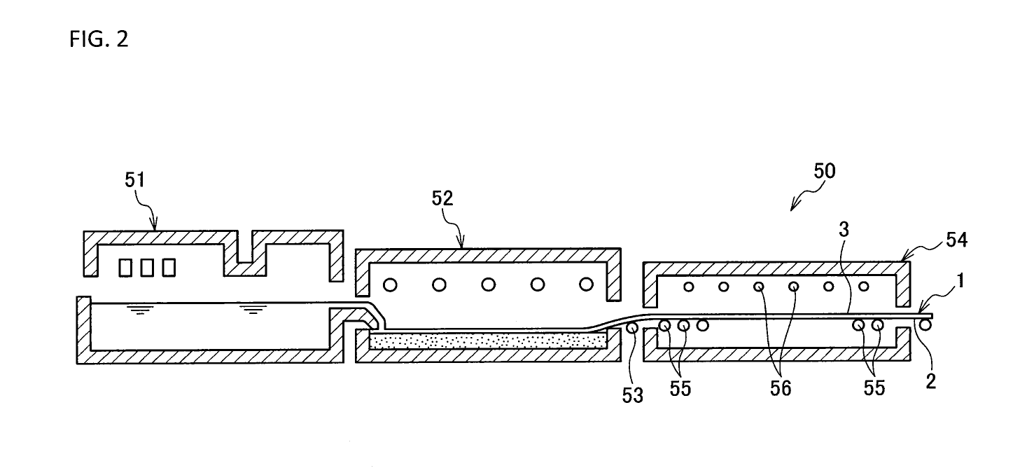

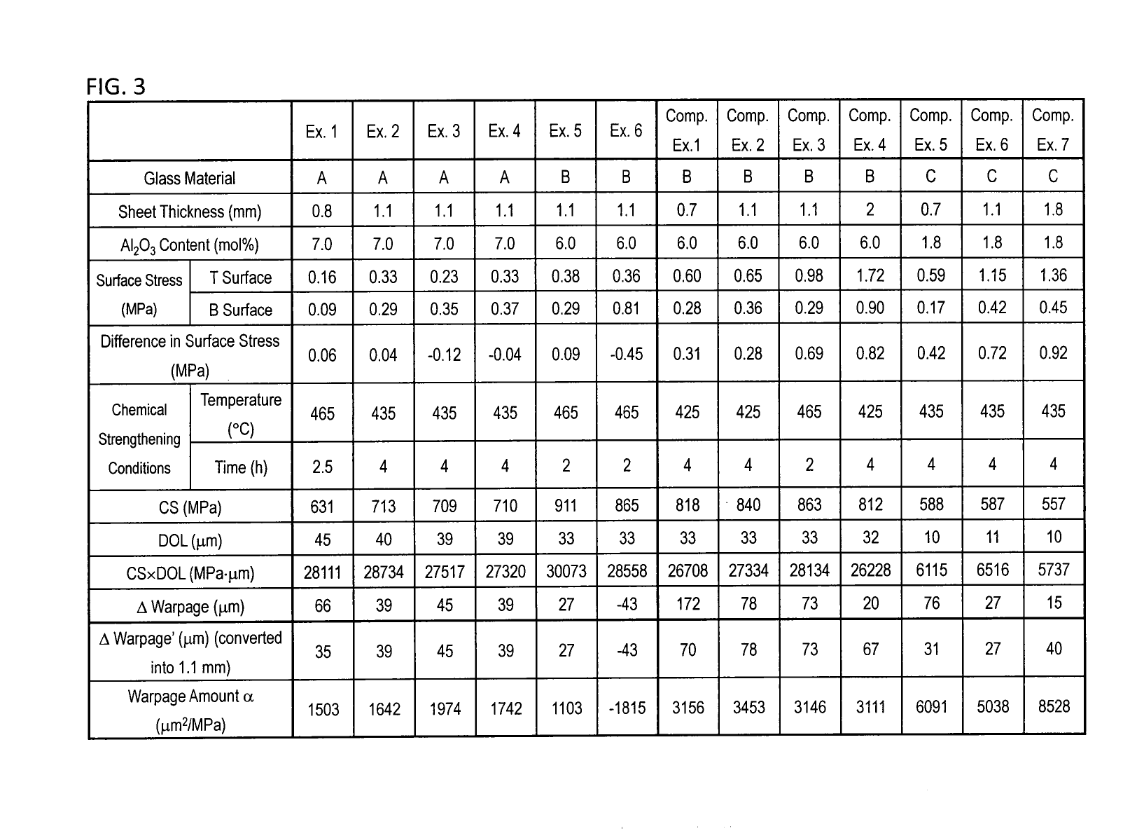

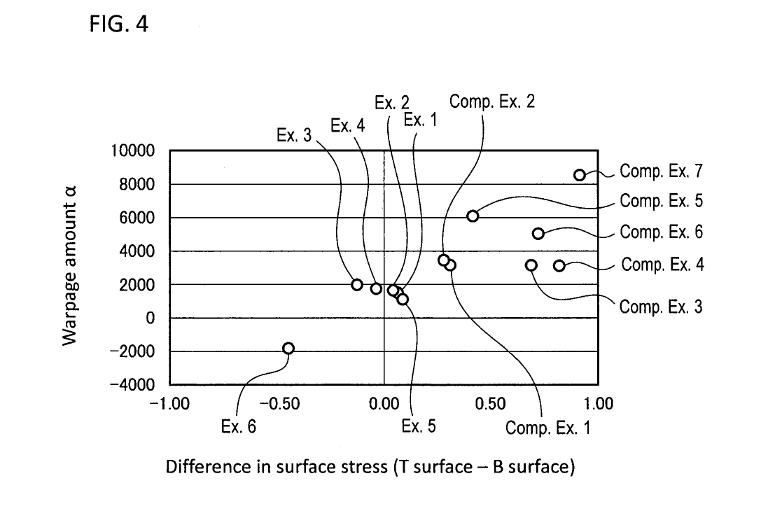

### BRIEF DESCRIPTION OF THE DRAWINGS

[FIG. 1] FIG. 1 is a cross-sectional view of a flat panel display using a cover glass for chemical strengthening of the present invention.

[FIG. 2] FIG. 2 is a schematic view schematically showing a glass production apparatus. [FIG. 3] FIG. 3 is a table showing respective values of Examples and Comparative Examples.

[FIG. 4] FIG. 4 is a graph showing the relationship between the difference in surface (compressive) stress of float grasses for chemical strengthening before chemical strengthening and the warpage amount.

### MODE FOR CARRYING OUT THE INVENTION

A float glass for chemical strengthening of the present invention is described below. First, an example where the float glass for chemical strengthening of the present invention is chemically strengthened, and then used as a cover glass for a flat panel display, is described.

FIG. 1 is a cross-sectional view of a display device in which the cover glass is arranged. In the following description, front-back and right-left are based on the directions of arrows in the drawing.

As shown in FIG. 1, the display device 10 includes a display panel 20 generally mounted in a chassis 15 and a cover glass 30 provided so as to cover the entire surface of the display panel 20 and to surround the front of the chassis 15.

The cover glass 30 is mainly arranged for the purpose of improvement in beauty and strength of the display device 10, prevention of impact failure, and the like, and is formed from one sheet of sheet-shaped glass in which the entire shape is nearly flat. As shown in FIG. 1, the glass cover 30 may be arranged so as to separate from a display side (front side) of the display panel 20 (so as to have an air layer), and may be attached to the display side of the display panel 20 through an adhesive film (not shown) having translucency.

A functional film 41 is provided on the front surface of the cover glass 30 where light from the display panel 20 is emitted, and a functional film 42 is provided on the back surface where light from the display panel 20 enters, in a position corresponding to the display panel 20. The functional films 41 and 42 are provided on both surfaces in FIG. 1. However, the present invention is not limited to this case, and the functional film may be provided on the front or back surface, or may be omitted.

The functional films 41 and 42 have functions, for example, such as reflection prevention of surrounding light, prevention of impact failure, shielding of electromagnetic waves, shielding of near infrared rays, correction of color tone and/or improvement of scratch resistance, and the thickness, the shape and the like are appropriately selected depending on the intended use. The functional films 41 and 42 are formed, for example, by attaching films made of a resin to the cover glass 30, or may be formed by a thin film formation method such as a deposition method, a sputtering method or a CVD method.

The reference numeral 44 is a black layer, and, for example, a coating film formed by applying an ink containing pigment particles to the cover glass 30 and subjecting it to ultraviolet irradiation or heating and burning, followed by cooling. The display panel 20 or the like is made invisible from the outside of the chassis 15 by the black layer 44, thereby improving sensuousness of appearance.

Typically, in the cover glass 30, the front surface where light from the display panel 20 is emitted is a top surface of the chemically strengthened float glass formed by a float process, and the back surface where light from the display panel 20 enters is a bottom surface of the chemically strengthened float glass. However, the present invention is not necessarily limited thereto. The front surface where light from the display panel 20 is emitted may be the bottom surface of the chemically strengthened float glass, and the back surface where light from the display panel 20 enters may be the top surface of the chemically strengthened float glass. The bottom surface means a surface coming into contact with a molten metal (typically, molten tin) during float forming, and the top surface means a surface facing the bottom surface.

FIG. 2 is a schematic view of a glass production apparatus for producing this cover glass 30.

The glass production apparatus 50 is constituted by including a melting furnace 51 for melting raw materials for glass, a float bath 52 for floating a molten glass melted on molten tin to form a flat glass ribbon, and a slow cooling furnace 54 for performing slow cooling by gradually decreasing the temperature of the glass ribbon after the glass ribbon is drawn out from the float bath 52 by a lift-out roller 53.

The slow cooling furnace 54 has, for example, a function of slowly cooling the glass ribbon conveyed by conveying rollers 55 to a temperature region near ordinary temperature by feeding the amount of heat whose output is controlled by heating means 56 such as combustion gas or electric heaters to required positions required in the furnace, thereby reducing residual stress inherent in the glass ribbon to suppress the occurrence of warpage or cracks in the glass.

A float glass 1 for chemical strengthening taken out of the slow cooling furnace 54 is cut to a predetermined size by a cutter not shown, and then, chemically strengthened. The chemical strengthening is a treatment of forming a compressive stress layer on a glass surface by exchanging an alkali metal ion having a small ion radius (typically, Li ion or Na ion) on a glass surface for an alkali ion having a larger ion radius (typically, K ion) by ion exchange at a temperature equivalent to or lower than the glass transition temperature.

The float glass 1 for chemical strengthening of the present invention is intended for a float glass for chemical strengthening, in which chemical strengthening is performed by immersion in a potassium nitrate (KNO₃) molten salt of 425 to 465° C. for 2 to 4 hours, the surface compressive stress is 600 MPa or more, and the depth of the compressive stress layer at that time is 15 μm or more. Further, the compressive stress of a chemically strengthened float glass is preferably 700 MPa or more, and the depth of the compressive stress layer is more preferably 30 μm or more. Furthermore, if the warpage amount α (μm²/MPa) is defined as α=(t×T²)/(σ×L), where the amount of change in warpage (the difference in height) of the float glass before and after chemical strengthening is t (μm), the sheet thickness of the chemically strengthened float glass is T (μm), the surface compressive stress value after chemical strengthening is σ (MPa), and the depth of the compressive stress layer is L (μm), the warpage amount α is preferably −2500 μm²/MPa or more and 2500 μm²/MPa or less, and more preferably −2000 μm²/MPa or more and 2000 μm²/MPa or less. The surface compressive stress and the depth of the compressive stress layer are values measured using a glass surface stress meter (FSM-6000) manufactured by Orihara Manufacturing Co., Ltd.

Here, the float glass 1 for chemical strengthening of the present invention is formed in such a manner that, if the surface to come into contact with the molten tin is a bottom surface 2 and the surface facing the bottom surface 2 is a top surface 3, the difference obtained by subtracting the surface compressive stress value σ_{CB} in the bottom surface 2 from the surface compressive stress value σ_{CT} in the top surface 3 is −0.6 MPa or more and 0.25 MPa or less, and more preferably −0.6 MPa or more and less than 0. This is based on the following reason.

In the chemical strengthening, the small alkali metal ion (typically, Li ion or Na ion) is substituted by the alkali ion having a larger ion radius (typically, substituted by K ion). As a result of various measurements and investigations, the present inventors have found that the larger the surface compressive stress is, the more easily this substitution tends to be performed. Accordingly, the larger difference in surface compressive stress between the bottom surface 2 and the top surface 3 leads to the larger difference in easiness of the substitution due to chemical strengthening, resulting in that the warpage due to chemical strengthening becomes apparent. The warpage is therefore suppressed by decreasing the difference in surface compressive stress between the bottom surface 2 and the top surface 3 in the float glass 1 for chemical strengthening.

Further, on the other hand, if the surface compressive stress value σ_{CB} in the bottom surface 2 is larger than the surface compressive stress value σ_{CT} in the top surface 3, the difference in surface compressive stress between the bottom surface 2 and the top surface 3 in the float glass 1 for chemical strengthening may be large to some extent. In the float glass 1 for chemical strengthening formed by the float process, the molten metal invades in the bottom surface 2, and, in chemical strengthening, this molten metal that has invaded suppresses the small alkali metal ion (typically, Li ion or Na ion) from being substituted by the alkali ion having a larger ion radius (typically, exchanged for K ion). Accordingly, the influence of the molten metal that has invaded in the bottom surface 2 can be cancelled by making larger the surface compressive stress in the bottom surface 2 than the surface compressive stress in the top surface 3.

In order to decrease the difference in surface compressive stress between the bottom surface 2 and the top surface 3 in the float glass 1 for chemical strengthening produced by the glass production apparatus 50, or to make larger the surface compressive stress in the bottom surface 2 than the surface compressive stress in the top surface 3, a method described in any one of the following (1) to (3) or a combination thereof can be adopted. (1) As a first method, the conveying speed of the glass ribbon is slowed down. The difference in temperature between the top surface 3 and the bottom surface 2 in the glass ribbon is decreased thereby to decrease the difference in surface compressive stress between the top surface 3 and the bottom surface 2. (2) As a second method, a surface of the glass ribbon is polished or etched. Portions influenced by the molten metal or the difference in slow cooling temperature during float forming are removed thereby to decrease the influence of the difference in surface compressive stress between the top surface 3 and the bottom surface 2. (3) As a third method, an annealing treatment is performed. In the annealing treatment, the float glass cooled to near room temperature is heated again to a temperature equivalent to or higher than the strain point, and is maintained for a predetermined period of time, followed by cooling. The surface compressive stress in the top surface 3 and that in the bottom surface 2 can be relaxed thereby.

The float glass 1 for chemical strengthening has a sheet thickness of preferably 1.5 mm or less and more preferably 0.5 to 1.1 mm. Further, an alkali aluminosilicate glass is preferred. For example, glasses having the following compositions are used.

(i) A glass containing, in a composition in terms of mol %, 50 to 80% of SiO₂, 2 to 25% of Al₂O₃, 0 to 10% of Li₂O, 0 to 18% of Na₂O, 0 to 10% of K₂O, 0 to 15% of MgO, 0 to 5% of CaO and 0 to 5% of ZrO₂, wherein, for example, “containing 0 to 10% of K₂O” means that K₂O is not essential, but may be contained within a range up to 10% and not impairing the object of the present invention (hereinafter the same).

(ii) A glass containing, in a composition in terms of mol %, 50 to 74% of SiO₂, 1 to 10% of Al₂O₃, 6 to 14% of Na₂O, 3 to 11% of K₂O, 2 to 15% of MgO, 0 to 6% of CaO and 0 to 5% of ZrO₂, provided that the total content of SiO₂ and Al₂O₃ is 75% or less, the total content of Na₂O and K₂O is from 12 to 25%, and the total content of MgO and CaO is from 7 to 15%.

(iii) A glass containing, in a composition in terms of mol %, 68 to 80% of SiO₂, 4 to 10% of Al₂O₃, 5 to 15% of Na₂O, 0 to 1% of K₂O, 4 to 15% of MgO and 0 to 1% of ZrO₂.

(iv) A glass containing, in a composition in terms of mol %, 67 to 75% of SiO₂, 0 to 4% of Al₂O₃, 7 to 15% of Na₂O, 1 to 9% of K₂O, 6 to 14% of MgO and 0 to 1.5% of ZrO₂, provided that the total content of SiO₂ and Al₂O₃ is from 71 to 75%, the total content of Na₂O and K₂O is from 12 to 20%, and if CaO is contained, the content thereof is less than 1%.

(v) A glass containing, in a composition in terms of mol %, 56 to 75% of SiO₂, 5 to 20% of Al₂O₃, 8 to 22% of Na₂O, 0 to 10% of K₂O, 0 to 14% of MgO, 0 to 5% of ZrO₂ and 0 to 5% of CaO.

### EXAMPLES

Examples of the present invention are described below.

Using 3 kinds of the following glass materials A to C, 13 kinds of float glasses for chemical strengthening having a thickness of 0.8 to 1.1 mm of Examples 1 to 6 and Comparative Examples 1 to 7 were produced by a float process, and chemical strengthening was performed by immersing them in a potassium nitrate (KNO₃) molten salt of 425 to 465° C. for 2 to 4 hours.

The glass material A is a glass containing, in a composition in terms of mol %, 73% of SiO₂, 7.0% of Al₂O₃, 14% of Na₂O and 6% of MgO.

The glass material B is a glass containing, in a composition in terms of mol %, 64.3% of SiO₂, 6.0% of Al₂O₃, 12% of Na₂O, 4% of K₂O, 11% of MgO, 0.1% of CaO, 0.1% of SrO and 2.5% of ZrO₂.

The glass material C is a glass containing, in a composition in terms of mol %, 71.5% of SiO₂, 1.8% of Al₂O₃, 12% of Na₂O, 0.9% of K₂O, 4.2% of MgO and 8.7% of CaO.

Then, regarding these float glasses for chemical strengthening of Examples 1 to 6 and Comparative Examples 1 to 7, the surface stress was measured, and the difference in surface stress which is the difference in surface stress between a top surface and a bottom surface was calculated. Further, regarding chemically strengthened float glasses obtained by chemically strengthening these float glasses for chemical strengthening of Examples 1 to 6 and Comparative Examples 1 to 7, the average value of surface stress (CS), the depth of a compressive stress layer (DOL) and the amount of change in warpage of the float glass before and after chemical strengthening (Δ warpage) were measured, and the warpage amount α was calculated. Since the warpage is inversely proportional to the square of the sheet thickness, regarding the amount of change in warpage of the float glass before and after chemical strengthening (Δ warpage) in Example 1 and Comparative Examples 1, 4, 5 and 7, the sheet thickness was converted into 1.1 mm using the following conversion formula (1). FIG. 3 is a table showing measured values and calculated values in these Examples 1 to 6 and Comparative Examples 1 to 7. Further, in Examples 5 and 6, an annealing treatment was performed by a method of elevating the temperature to 600° C. at 10° C./min before chemical strengthening and maintaining at 600° C. for 1 hour, followed by cooling at 0.5° C./min.

Δ warpage′=Δ warpage×t²/t′² (1)

Δ warpage' is the converted amount of change in warpage of the float glass before and after chemical strengthening, t is the original sheet thickness, and t′ is the converted sheet thickness (1.1 mm in this Example).

The surface stress was measured as follows.

First, the float glass for chemical strengthening was cut out into a size of 20 mm×5 mm, and correcting of parallelism of long sides was performed, followed by mirror polishing. Subsequently, the retardation was measured by Abrio manufactured by Hinds Instruments, Inc.

Next, the surface compressive stress σ was determined based on the following formula (2):

Surface compressive stress (MPa)=retardation (nm)/photoelastic constant (nm/MPa/cm)/optical path length (cm) (2)

The stress value was calculated so as to express compression as a plus and stretching as a minus. Since it is difficult to measure the stress value in the vicinity of the surface, there were used data from a point 10 μm apart from the surface to a point where the stress value was reduced to zero. Taking the surface position as zero, data plots were linearly approximated, and a point of intersection thereof with the abscissa axis was used as the surface stress value. The value obtained by subtracting the surface stress value in the bottom surface from the surface stress value in the top surface was defined as the difference in surface stress.

The average value of surface stress (CS) and the depth of the compressive stress layer (DOL) were measured using a glass surface stress meter (FSM-6000) manufactured by Orihara Manufacturing Co., Ltd. The warpage was measured before and after chemical strengthening using a three-dimensional shape measuring device (model number: NH-3MA) manufactured by Mitaka Kohki Co., Ltd. The value obtained by subtracting the warpage before chemical strengthening from the warpage after chemical strengthening was defined as the warpage (Δ warpage).

From the results of FIG. 3 and FIG. 4, regarding Comparative Examples 5 to 7, the surface compressive stress was less than 600 MPa, and did not satisfy 600 MPa as the demanded surface compressive stress. Further, regarding all of them, the depth of the compressive stress layer (DOL) was within a range of 10 to 11 μm, and did not satisfy 15 μm as the demanded depth of the compressive stress layer (DOL). Furthermore, the warpage amount α was also 5000 μm²/MPa or more, and the warpage to strengthening was large.

Regarding Comparative Examples 1 to 4, the surface compressive stress was 600 MPa, and the depth of the compressive stress layer (DOL) was within a range of 30 to 35 μm. The demanded surface compressive stress and depth of the compressive stress layer (DOL) were satisfied. However, as shown in FIG. 3 and FIG. 4, the difference in surface compressive stress before chemical strengthening exceeded 0.25 MPa, the rate of change in warpage before and after chemical strengthening was as large as 67 μm or more, and the warpage amount α exceeded 3000 μm²/MPa.

In contrast, regarding Examples 1 to 6, the surface compressive stress was 600 MPa, and the depth of the compressive stress layer (DOL) was within a range of 30 to 45 μm. The demanded surface compressive stress and depth of the compressive stress layer (DOL) were satisfied. Further, as shown in FIG. 3 and FIG. 4, the difference in surface compressive stress before chemical strengthening was −0.6 MPa or more and 0.25 MPa or less, the rate of change in warpage before and after chemical strengthening was small, and the warpage amount α was 2000 μm²/MPa or less. Accordingly, regarding Examples 1 to 6, as shown in FIG. 3 and FIG. 4, the difference in surface compressive stress was −0.6 MPa or more and 0.25 MPa or less, resulting in that the warpage amount α could be decreased, compared to Comparative Examples 1 to 4.

As described above, according to the present embodiments, before chemical strengthening, the difference obtained by subtracting the surface compressive stress value σ_{CB} in the bottom surface from the surface compressive stress value σ_{CT} in the top surface in the float glass for chemical strengthening is −0.6 MPa or more and 0.25 MPa or less, resulting in that the warpage of the float glass due to chemical strengthening can be reduced.

Further, before chemical strengthening, the difference obtained by subtracting the surface compressive stress value σ_{CB} in the bottom surface from the surface compressive stress value σ_{CT} in the top surface in the float glass for chemical strengthening is −0.6 MPa or more and less than 0 MPa, resulting in that the influence of the molten metal that has invaded in the bottom surface can be cancelled, and the warpage can be more reduced.

The present invention is not construed as being limited to the above-mentioned embodiments in any way, and can be carried out in various modes within a scope not departing from the gist thereof.

This application is based on Japanese Patent Application No. 2011-147493 filed on Jul. 1, 2011, the contents of which are incorporated herein by reference.

### DESCRIPTION OF REFERENCE NUMERALS AND SIGNS

1 Float glass for chemical strengthening
2 Bottom surface
3 Top surface
10 Display device
15 Chassis
20 Display panel
30 Cover glass
50 Glass production apparatus
51 Melting furnace
52 Float bath
53 Lift-out roller
54 Slow cooling furnace
55 Conveying roller
56 Heating means

1. A float glass, which is produced by a float process, has a bottom surface to contact a molten metal during forming and a top surface facing the bottom surface, and is capable of having, after chemical strengthening, a surface compressive stress of 600 MPa or more and a depth of a compressive stress layer of 15 μm or more from a surface thereof,
wherein, before chemical strengthening, a difference obtained by subtracting a surface compressive stress value σ_{CB} in the bottom surface from a surface compressive stress value σ_{CT} in the top surface is −0.6 MPa or more and 0.25 MPa or less.

2. The float glass according to claim 1, wherein, before chemical strengthening, the difference obtained by subtracting the surface compressive stress value σ_{CB} in the bottom surface from the surface compressive stress value σ_{CT} in the top surface is less than 0 MPa.

3. The float glass according to claim 1, which has a sheet thickness of 1.5 mm or less.

4. The float glass according to claim 2, which has a sheet thickness of 1.5 mm or less.

5. The float glass according to claim 1, which is an alkali aluminosilicate glass.

6. The float glass according to claim 2, which is an alkali aluminosilicate glass.

7. The float glass according to claim 3, which is an alkali aluminosilicate glass.

8. The float glass according to claim 4, which is an alkali aluminosilicate glass.
